(19) United States
(12) Patent Application Publication
(10) Pub. No.: US 2010/0316925 A1
(43) Pub. Date: Dec. 16, 2010

(54) FUEL CELL SYSTEM

(75) Inventors: Cheng Wang, Hsinchu (TW); Po-Kuei Chou, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: YOUNG GREEN ENERGY CO., HSINCHU COUNTY (TW)

(21) Appl. No.: 12/774,729

(22) Filed: May 6, 2010

(30) Foreign Application Priority Data
Jun. 12, 2009 (TW) 98119866

(51) Int. Cl. H01M 8/04

(52) U.S. Cl. 429/441

(57) ABSTRACT

A fuel cell system including a fuel cell module, a heat generation module, and a fuel supplying module is provided. The fuel supplying module supplies a fuel gas to the heat generation module. Heat generated by the fuel gas burned in the heat generation module is used for heating the fuel cell module.

### CROSS-REFERENCE TO RELATED APPLICATION

This application claims the priority benefit of Taiwan application serial No. 98119866, filed on Jun. 12, 2009. The entirety of the above-mentioned patent application is hereby incorporated by reference herein and made a part of this specification.

### BACKGROUND OF THE INVENTION

1. Field of the Invention

The present invention relates to a cell system. More particularly, the present invention relates to a fuel cell system.

2. Description of Related Art

Since a fuel cell has advantages of high efficiency, low noise, non-pollution, etc, it becomes a trend in energy. The fuel cells can be categorized into various types, such as, proton exchange membrane fuel cells (PEMFC) and direct methanol fuel cells (DMFC). Taking the DMFC as an example, a DMFC module consists of a proton exchange membrane and a cathode and an anode respectively disposed at both sides of the proton exchange membrane.

Performance of the fuel cell greatly depends on temperature. When a reaction temperature is low, a catalyst activity of the fuel cell is low, so that the performance of the fuel cell is poor. Conversely, when the reaction temperature is high, the catalyst activity is high, so that the performance of the fuel cell is correspondingly improved. Patents related to the fuel cell are the U.S. Pat. No. 6,986,957, the Japan patent No. 5-307970, and the Taiwan patent publication No. 200512040. In a disclosure of the Taiwan patent publication No. 200512040, the catalyst of the fuel cell is, for example, a boron nitride (BN) supported precious metal catalyst.

### SUMMARY OF THE INVENTION

The present invention is directed to a fuel cell system which could be operated under a low temperature environment.

Additional aspects and advantages of the present invention will be set forth in the description of the techniques disclosed in the present invention.

The present invention provides a fuel cell system including a fuel cell module, a heat generation module, and a fuel supplying module. The fuel supplying module is for supplying a fuel gas to the heat generation module. Heat generated by the fuel gas burned in the heat generation module is used for heating the fuel cell module.

In an embodiment of the present invention, the fuel cell system uses the heat generated by the fuel gas burned in the heat generation module to heat the fuel cell module, so that the fuel cell module can still be normally operated under a low temperature environment.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram illustrating a fuel cell system according to an embodiment of the present invention.

FIG. 2 is a block diagram illustrating a fuel cell system according to another embodiment of the present invention.

FIG. 3 is a schematic diagram of a fuel supplying module of FIG. 2.

FIG. 4 is a block diagram illustrating a fuel cell system according to another embodiment of the present invention.

FIG. 5 is a schematic diagram of a fuel supplying module of FIG. 4.

FIG. 6 is a block diagram illustrating a fuel cell system according to another embodiment of the present invention.

FIG. 7 is a block diagram illustrating a fuel cell system according to another embodiment of the present invention.

FIG. 8 is a schematic diagram of a fuel supplying module of FIG. 7.

FIG. 9 is a block diagram illustrating a fuel cell system according to another embodiment of the present invention.

FIG. 10 is a schematic diagram of a transmission pipeline of FIG. 9.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

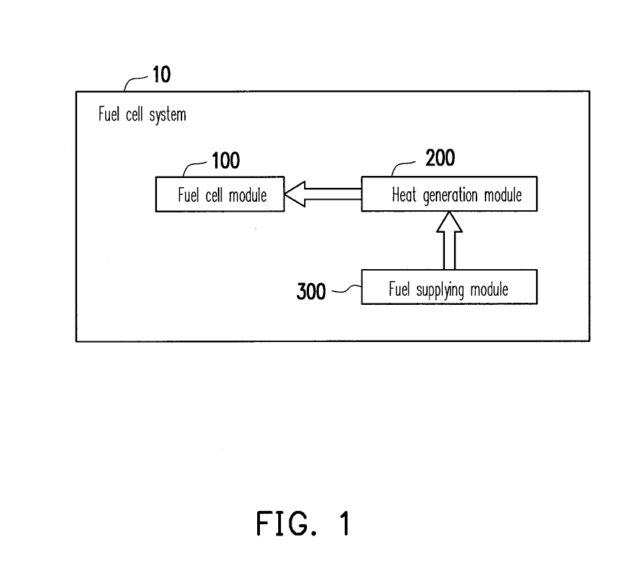

FIG. 1 is a block diagram illustrating a fuel cell system according to an embodiment of the present invention. Referring to FIG. 1, in the present invention, the fuel cell system 10 includes a fuel cell module 100, a heat generation module 200 and a fuel supplying module 300. The fuel supplying module 300 supplies a fuel gas to the heat generation module 200, wherein the fuel gas is, for example, methanol (CH₃OH). The heat generated by the fuel gas burned in the heat generation module 200 is used for heating the fuel cell module 100. Therefore, the fuel cell module 100 could be continually heated to reach an operating temperature, so that it could still be normally operated under a low temperature environment.

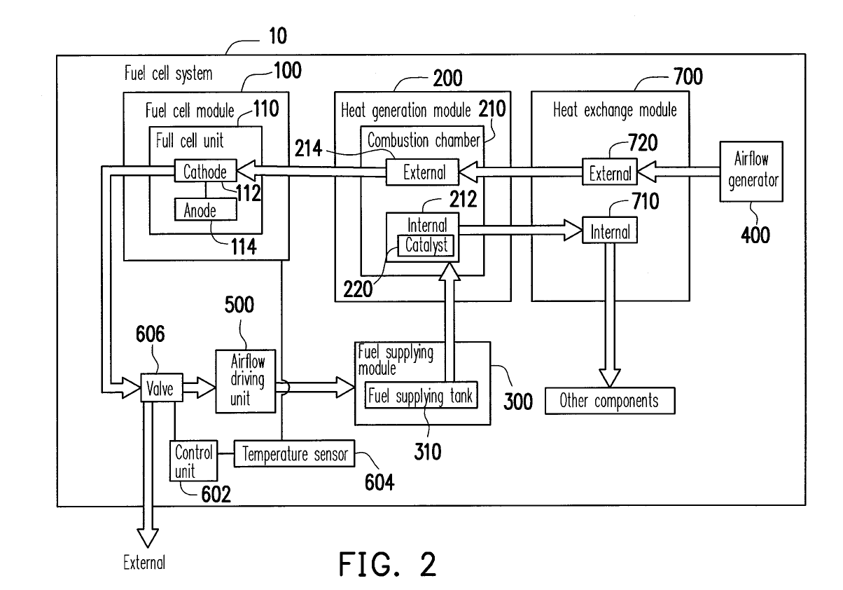

### An Embodiment of FIG. 2

FIG. 2 is a block diagram illustrating a fuel cell system according to another embodiment of the present invention. Referring to FIG. 2, in the present embodiment, the fuel cell system 10 could include an airflow generator 400, which is used for generating an airflow. Moreover, the fuel cell module 100 includes a fuel cell unit 110 having a cathode 112 and an anode 114.

The fuel gas provided by the fuel supplying module 300 is burned in the heat generation module 200, and the heat generated in the heat generation module 200 is quickly guided to the fuel cell module 100 by the airflow. In detail, the airflow generated by the airflow generator 400 flows through external 214 of the heat generation module 200, and is heated by vapor in internal 212 of the heat generation module 200, so that the hot air could be supplied to the cathode 112. Therefore, the cathode 112 receive the hot air with a relatively high temperature and takes it as a reactant, so that the fuel cell module 100 could still reach the operating temperature under the low temperature environment, and accordingly the fuel cell system 10 could be operated under the low temperature environment.

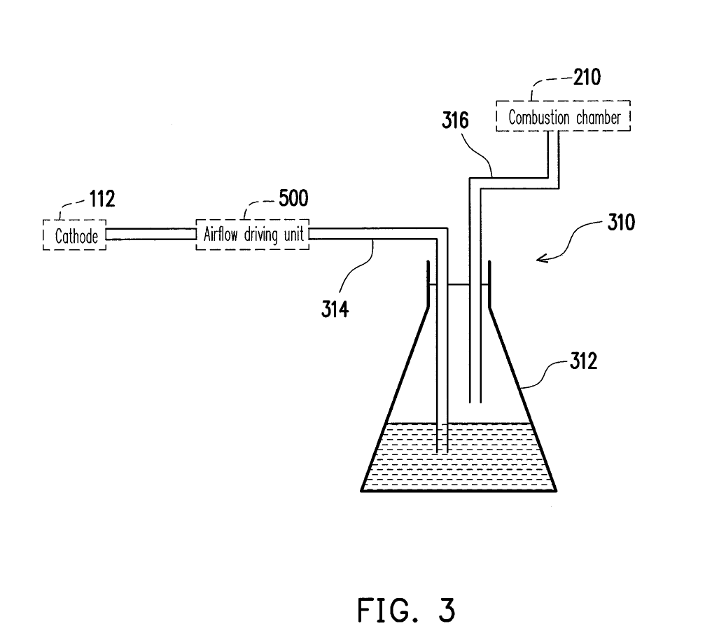

FIG. 3 is a schematic diagram of the fuel supplying module of FIG. 2. Referring to FIG. 2 and FIG. 3, the fuel supplying module 300 includes a fuel supplying tank 310, and the fuel supplying tank 310 can supply the fuel gas to the heat generation module 200. In detail, the fuel supplying tank 310 has a container 312 and two pipes 314 and 316, wherein the container 312 is filled with fuel liquid. One end of the pipe 314 is connected to the cathode 112 of the fuel cell unit 110, and an opening of another end of the pipe 314 is disposed in the fuel liquid of the container 312. Namely, a height of the opening of another end of the pipe 314 is lower than a liquid level of the fuel liquid. On the other hand, the pipe 316 connects the container 312 and a combustion chamber 210 of the heat generation module 200. In detail, one end of the pipe 316 is connected to the combustion chamber 210, and an opening of another end of the pipe 316 is disposed in the container 312, wherein a height of the opening of another end of the pipe 316 is higher than the liquid level of the fuel liquid. Therefore, after the air and the fuel in the container 312 are mixed, the saturated fuel gas can enter the combustion chamber 210 through the pipe 316.

Additionally, the fuel cell system 10 can further include an airflow driving unit 500 disposed between the cathode 112 and the pipe 314, which is used for driving the air into the container 312 through the pipe 314. After the air and the fuel in the container 312 are mixed, the saturated fuel gas can enter the combustion chamber 210 through the pipe 316. The heat generated by the fuel gas burned in the internal 212 of the combustion chamber 210 could be carried away by the airflow flowed through the external 214 of the combustion chamber 210, and the heat is supplied to the cathode 112. On the other hand, the heat generated by the fuel gas burned in the internal 212 of the combustion chamber 210 could also be guided to the other components of the fuel cell system 10, so as to improve whole temperature of the fuel cell system 10.

It should be noticed that the heat generation module 200 may have a catalyst 220 disposed in the internal 212 of the combustion chamber 210. In the present embodiment, the catalyst 220 is, for example, a boron nitride (BN) supported precious metal catalyst. Since BN has an inactivate chemical property, and has a good hydrophobic property, when the fuel gas is burned in the combustion chamber 210, the fuel gas is not liable to have a chemical reaction with the BN, so that generation of unnecessary intermediate could be avoided. Moreover, the vapor, generated after the fuel gas is burned, is not liable to be coagulated on a surface of the BN, so that reaction efficiency is steady.

In the present embodiment, the fuel cell system 10 could further include a control unit 602, a temperature sensor 604, and a valve 606, wherein the temperature sensor 604 and the valve 606 are electrically connected to the control unit 602. When the temperature sensor 604 senses that a temperature of the fuel cell module 100 is lower than a predetermined value (for example, 5° C.), the control unit 602 opens the valve 606, so that the air from the fuel cell module 100 flows through the fuel supplying module 300 to the heat generation module 200.

Therefore, when the fuel cell system 10 is at low temperature and does not be normally operated, the control unit 602 opens the valve 606, so that the heat generation module 200 could receive the fuel gas supplied by the fuel supplying module 300 and start to generate the heat. By such means, the fuel cell module 100 could be heated by the heat generated by the fuel gas burned in the heat generation module 200, so as to reach the operating temperature.

Conversely, when the temperature sensor 604 senses that the temperature of the fuel cell module 100 is higher than the predetermined value, the control unit 602 closes the valve 606 to stop the operation of the heat generation module 200.

Moreover, to achieve a better heat exchange efficiency, the fuel cell system 10 could further include a heat exchange module 700 connected to the heat generation module 200. Therefore, the vapor generated by the fuel gas burned in the internal 212 of the combustion chamber 210 of the heat generation module 200 can flow through internal 710 of the heat exchange module 700 to exchange the heat with the airflow flowed through the external 720 of the heat exchange module 700.

In detail, the airflow generated by the airflow generator 400 could sequentially flow through the external 720 of the heat exchange module 700 and the external 214 of the combustion chamber 210, so as to exchange the heat with the vapor in the internal 710 of the heat exchange module 700 and the internal 212 of the combustion chamber 210. Thereafter, the heated airflow can flow to the cathode 112 to heat the cathode 112. In the present embodiment, the heat exchange module 700 is, for example, a pipe, and an outer surface of the pipe may have a plurality of fins, so as to improve a heat contact area.

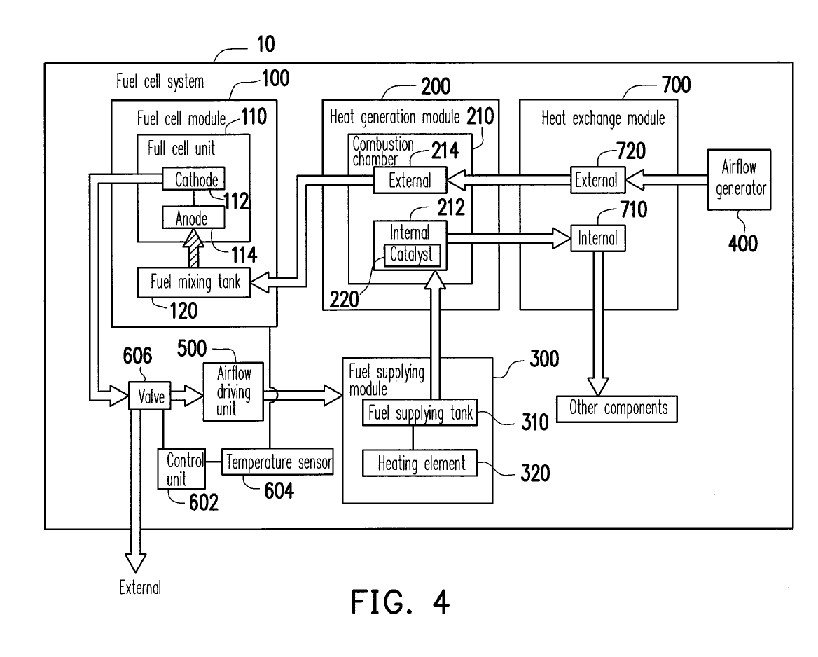

### An Embodiment of FIG. 4

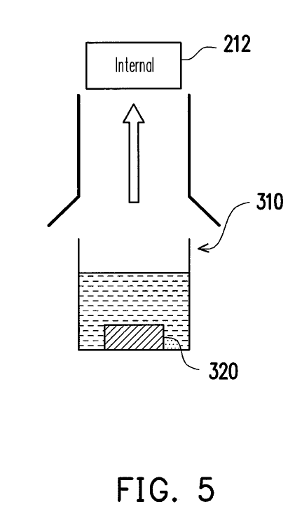

FIG. 4 is a block diagram illustrating a fuel cell system according to another embodiment of the present invention. FIG. 5 is a schematic diagram of a fuel supplying module of FIG. 4. Referring to FIG. 4 and FIG. 5, in the present embodiment, the fuel cell module 100 includes a fuel mixing tank 120, which is used for supplying the fuel liquid to the anode 114.

Moreover, the fuel supplying module 300 includes a heating element 320 which is used for heating the fuel to vaporize a part of the fuel (phase transition from a liquid phase to a gas phase). The fuel gas and the air can enter the internal 212 of the combustion chamber 210, and the heat generated in the internal 212 of the combustion chamber 210 can be carried away by the airflow flowed through the external 214 of the combustion chamber 210. The heated airflow can flow to the fuel mixing tank 120 to heat the fuel in the fuel mixing tank 120.

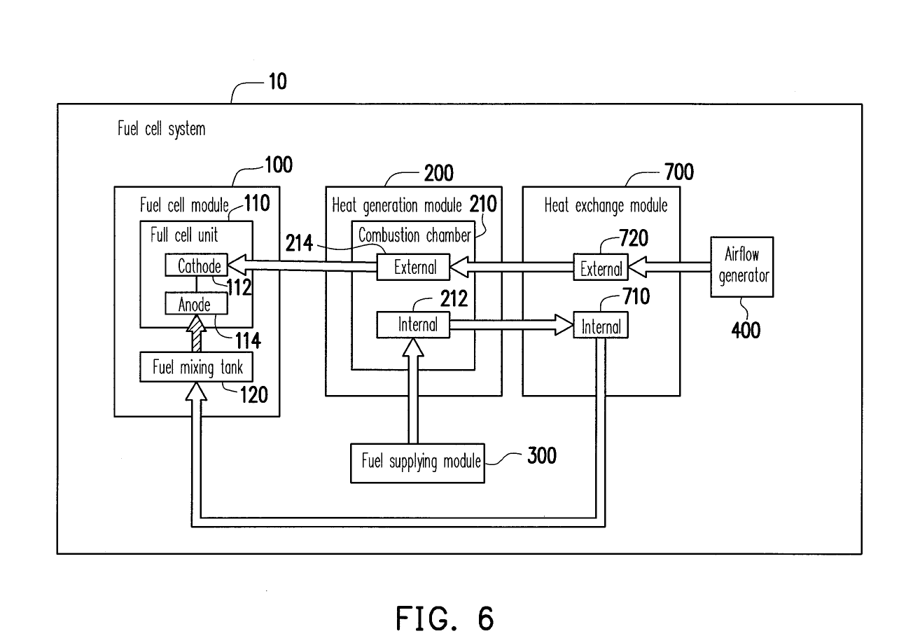

### An Embodiment of FIG. 6

FIG. 6 is a block diagram illustrating a fuel cell system according to another embodiment of the present invention. Referring to FIG. 6, the heat generated by the fuel gas burned in the internal 212 of the combustion chamber 210 could be quickly supplied to the cathode 112 of the fuel cell module 100 through the airflow.

On the other hand, the vapor generated by the fuel gas burned in the internal 212 of the combustion chamber 210 could flow through the internal 710 of the heat exchange module 700 to the fuel mixing tank 120 for heating the fuel liquid in the fuel mixing tank 120.

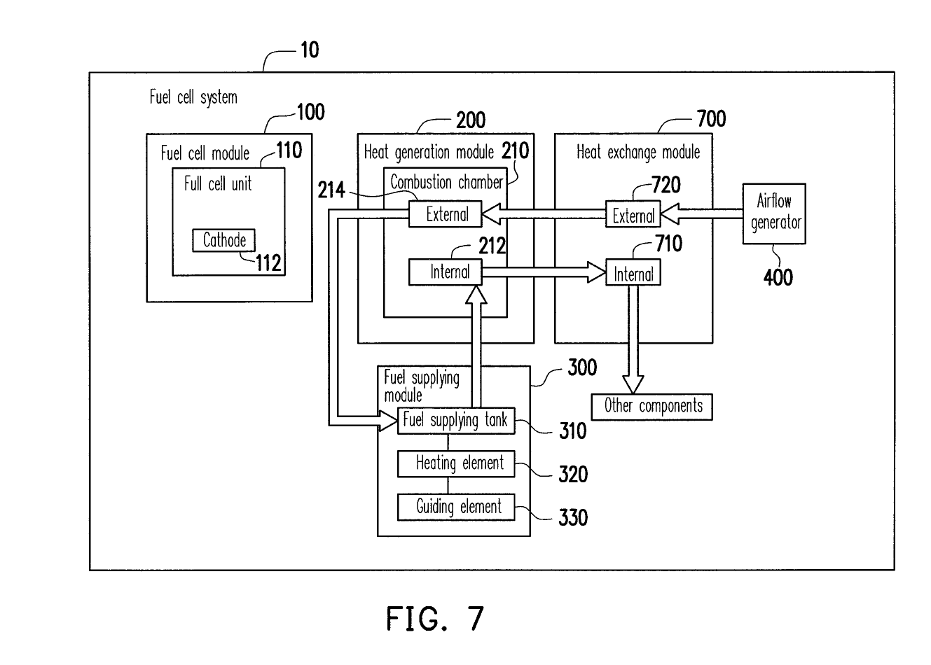

### An Embodiment of FIG. 7

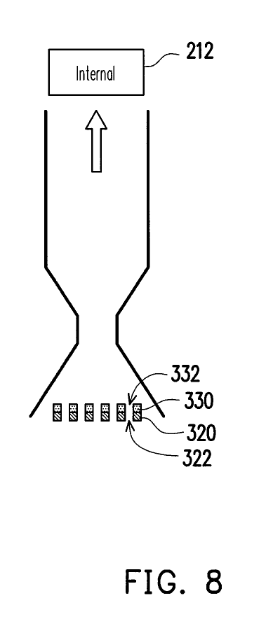

FIG. 7 is a block diagram illustrating a fuel cell system according to another embodiment of the present invention. FIG. 8 is a schematic diagram of a fuel supplying module of FIG. 7. Referring to FIG. 7 and FIG. 8, in the present embodiment, the fuel supplying module 300 could further include a guiding element 330, which is used for guiding the fuel in the fuel supplying tank 310 to the heating element 320.

In detail, the heating element 320 has a flat-plate profile, and has a plurality of first through holes 322. The guiding element 330 is a carbon cloth having a plurality of second through holes 332. The carbon cloth is disposed on the heating element 320 and adsorbs the fuel liquid. The heating element 320 could heat the carbon cloth to vaporize the fuel liquid adsorbed by the carbon cloth, and the vaporized fuel liquid enters the combustion chamber 210. External air is capable of flowing through the heating element 320 and the carbon cloth sequentially to reach the heat generation module 200.

It should be noticed that the first through holes 322 are disposed corresponding to the second through holes 332. Therefore, the airflow flowed through the external 720 of the heat exchange module 700 and the external 214 of the combustion chamber 210 could sequentially pass through the first through holes 322 and the second through holes 332, and flows to the internal 212 of the combustion chamber 210 to receive the heat of the fuel gas burned therein. Thereafter, the airflow could flow through the internal 710 of the heat exchange module 700, so as to supply the heat to the fuel cell module 100 or the other components of the fuel cell system 10 to improve a whole temperature of the fuel cell system 10.

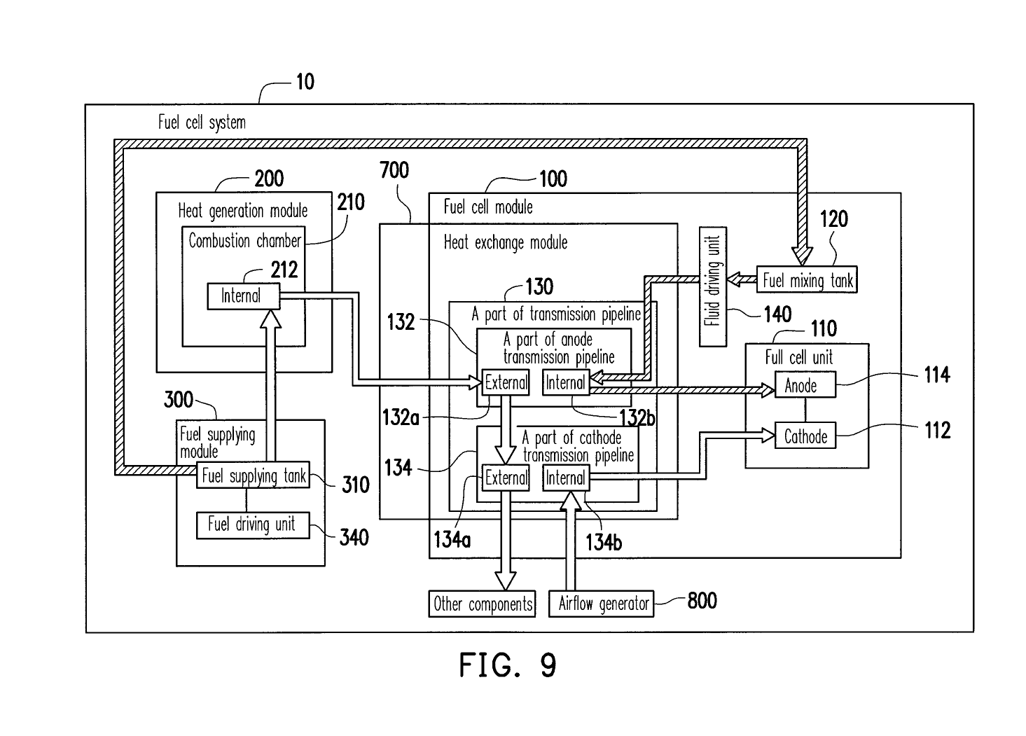

### An Embodiment of FIG. 9

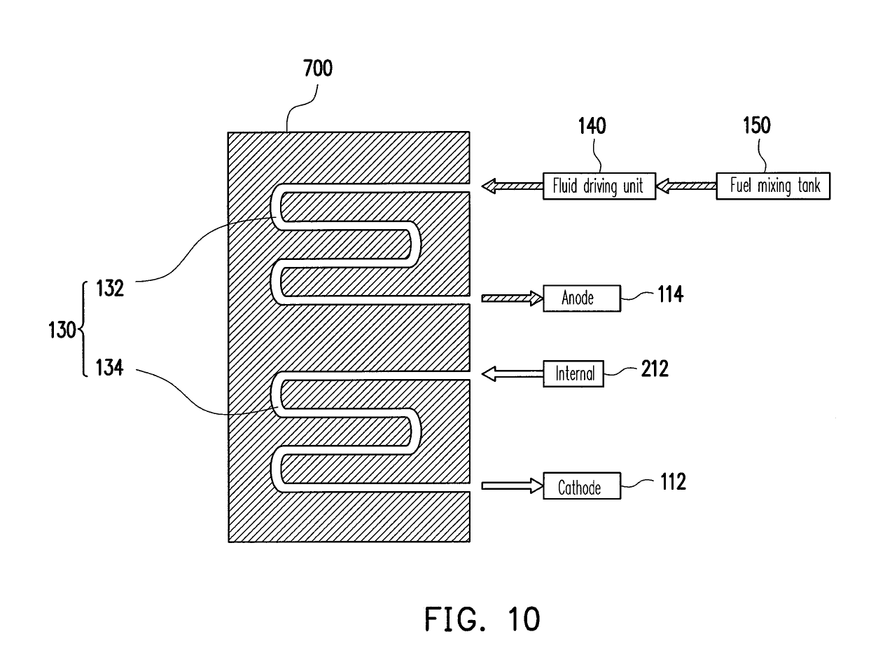

FIG. 9 is a block diagram illustrating a fuel cell system according to another embodiment of the present invention. FIG. 10 is a schematic diagram of a transmission pipeline of FIG. 9. Referring to FIG. 9 and FIG. 10, in the present embodiment, the fuel cell module 100 includes a transmission pipeline 130 and a fluid driving unit 140. Moreover, the fuel supplying module 300 further includes a fuel driving unit 340, which is used for driving the fuel to flow from the fuel supplying tank 310 to the fuel mixing tank 120.

The transmission pipeline 130 has an anode transmission pipeline 132 and a cathode transmission pipeline 134. It should be noticed that a part of the anode transmission pipeline 132 and a part of the cathode transmission pipeline 134 are disposed in the heat exchange module 700.

In detail, after the fuel gas is burned in the internal 212 of the combustion chamber 210, the vapor generated due to the burning of the fuel gas could sequentially flow through the external 132a of the anode transmission pipeline 132 and the external 134a of the cathode transmission pipeline 134, so as to heat the anode transmission pipeline 132 and the cathode transmission pipeline 134. Thereafter, the vapor could be guided to other components of the fuel cell system 10 to improve the whole temperature of the fuel cell system 10.

In addition, the fuel cell system 10 could further include an airflow generator 800, which is used for transmitting the air in the fuel cell system 10 to the cathode 112 through the internal 134b of the cathode transmission pipeline 134. Therefore, the cathode 112 could receive the hot air heated by the vapor flowed through the external 134a of the cathode transmission pipeline 134 and take the hot air as the reactant.

On the other hand, the fuel fluid in the fuel mixing tank 120 could be driven by the fluid driving unit 140, and flows through the internal 132b of the anode transmission pipeline 132 to the anode 114. Therefore, the fuel fluid supplied to the anode 114 could also be heated by the vapor flowed through the external 132a of the anode transmission pipeline 132.

Therefore, the fuel cell unit 110 could respectively receive the high temperature fuel and the hot air through the anode transmission pipeline 132 and the cathode transmission pipeline 134 and take the high temperature fuel and the hot air as the reactants. By such means, a reaction speed of the fuel cell module 100 could be effectively increased, so that the power efficiency of the fuel cell system 10 is better.

In summary, the embodiment or the embodiments of the present invention may have at least one of the following advantages, the fuel cell system could use the heat generated by the fuel gas burned in the heat generation module to heat the fuel cell module, so that the fuel cell module in the low temperature environment could reach the operating temperature and is operated normally. Moreover, the heat generation module could use the BN as the catalyst, so that when the fuel gas is burned in the combustion chamber, it is not liable to have a chemical reaction with the BN. Moreover, the vapor generated after the fuel gas is burned is not liable to be coagulated on the surface of the BN, so that a certain reaction efficiency is maintained.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A fuel cell system, comprising:
a fuel cell module;
a heat generation module; and
a fuel supplying module for supplying a fuel gas to the heat generation module, and heat generated by the fuel gas burned in the heat generation module being used for heating the fuel cell module.

2. The fuel cell system as claimed in claim 1, further comprising:
an airflow generator for generating an airflow, wherein the airflow flowing through external of the heat generation module is heated by the heat generation module, and is supplied to the fuel cell module.

3. The fuel cell system as claimed in claim 1, wherein the fuel cell module comprises:
a fuel cell unit having a cathode and an anode; and
a fuel mixing tank for supplying a fuel liquid to the anode.

4. The fuel cell system as claimed in claim 3, wherein the airflow heated by the heat generation module is capable of flowing to the fuel cell unit for supplying a hot air to the cathode.

5. The fuel cell system as claimed in claim 3, wherein the airflow heated by the heat generation module is capable of flowing to the fuel mixing tank for heating fuel within the fuel mixing tank.

6. The fuel cell system as claimed in claim 1, further comprising:
an airflow driving unit for driving air into the heat generation module.

7. The fuel cell system as claimed in claim 1, further comprising:
a control unit;
a temperature sensor electrically connected to the control unit; and
a valve electrically connected to the control unit,
wherein the valve is open to allow the hot air from the fuel cell module entering the heat generation module when the temperature sensor senses that a temperature of the fuel cell module is lower than a predetermined value.

8. The fuel cell system as claimed in claim 1, wherein the fuel supplying module comprises:
a fuel supplying tank for supplying fuel to the heat generation module; and
a heating element for heating the fuel to vaporize a part of the fuel from a liquid state into a gas state.

9. The fuel cell system as claimed in claim 8, wherein the fuel supplying module comprises:
a guiding element for guiding the fuel in the fuel supplying tank to the heating element.

10. The fuel cell system as claimed in claim 9, wherein the heating element has a flat-plate profile, and the guiding element is a carbon cloth, the carbon cloth is disposed on the heating element, and external air is capable of flowing through the heating element and the carbon cloth sequentially to reach the heat generation module.

11. The fuel cell system as claimed in claim 9, wherein the fuel supplying module comprises:
a fuel driving unit for driving the fuel to flow from the fuel supplying tank to the fuel mixing tank.

12. The fuel cell system as claimed in claim 1, wherein the heat generation module has a combustion chamber and a catalyst configured in the combustion chamber.

13. The fuel cell system as claimed in claim 1, further comprising:
a heat exchange module connected to the heat generation module, wherein vapor generated after the fuel gas is burned in the heat generation module is capable of flowing through the heat exchange module for exchanging heat with a fluid flowing through the heat exchange module.

14. The fuel cell system as claimed in claim 13, wherein the heat exchange module is a pipe, and an outer surface of the pipe has a plurality of fins.

15. The fuel cell system as claimed in claim 13, wherein the fuel cell module comprises:
a transmission pipeline, a part of the transmission pipeline being disposed in the heat exchange module.

16. The fuel cell system as claimed in claim 15, wherein the fuel cell module comprises:
a liquid driving unit for driving a liquid in the transmission pipeline to the fuel cell unit.

17. The fuel cell system as claimed in claim 1, wherein the airflow flows into internal of the heat generation module to receive heat generated by the burned fuel gas to supply the heat to the fuel cell module after the airflow generated by the airflow generator flows through external of the heat generation module.

18. The fuel cell system as claimed in claim 13, wherein the airflow flows through internal of the heat generation module to receive heat generated by the burned fuel gas, and flows through internal of the heat exchange module to supply the heat to the fuel cell module after the airflow generated by the airflow generator sequentially flows through external of the heat exchange module and external of the heat generation module.
